(19) United States
(12) Patent Application Publication
(10) Pub. No.: US 2007/0243393 A1
(43) Pub. Date: Oct. 18, 2007

(54) SANDWICH COMPOSITE MATERIALS

(75) Inventors: K. Ranji Vaidyanathan, Tucson, AZ (US); Jeffrey Campbell, Tucson, AZ (US); Arthur R. Studley IV, Tucson, AZ (US); Christina Bisch, Tucson, AZ (US); John W. Gillespie JR., Hockessin, DE (US); Stephen M. Andersen, Elkton, MD (US); Ahmad Abed Abu Obaid, Newark, DE (US)

Correspondence Address: BANNER & WITCOFF, LTD., TEN SOUTH WACKER DRIVE, SUITE 3000, CHICAGO, IL, 60606, US

(73) Assignee: ADVANCED CERAMICS RESEARCH, INC., Tucson, AZ (US)

(21) Appl. No.: 11/552,760

(22) Filed: Oct. 25, 2006

Related U.S. Application Data
(60) Provisional application No. 60/729,732, filed on Oct. 25, 2005.

(51) Int. Cl. B32B 13/04; E04C 1/00

(52) U.S. Cl. 428/446; 428/411.1; 52/309.1

(57) ABSTRACT

Sandwich composite constructions with superior thermal and acoustic insulation properties are provided. In addition, the sandwich composite constructions are lightweight and have a mechanical integrity that may allow them to withstand an impact force of five pounds per square inch or more. One aspect of the present invention relates to the composition of the sandwich constructions, while another relates to methods of fabricating the sandwich composite constructions. Materials incorporated into the constructions include fibrous material, aerogel, resin, separation material, and insulating material, such as a foam. A vacuum assisted resin transfer method (VARTM) may be used to manufacture the sandwich composites by infusing resin into a composite preform such that the resin is received into at least a portion of the fibrous material pores. Water soluble tooling materials may be used as the substrate for the preform to fabricate sandwich composite panels having either simple or complex geometries.

### CROSS-REFERENCE TO RELATED APPLICATIONS

This application is based on, and claims the benefit of, U.S. Provisional Application No. 60/729,732, filed Oct. 25, 2005, and entitled “Sandwich Composite Materials,” which is incorporated herein by reference.

### STATEMENT REGARDING FEDERALLY SPONSORED RESEARCH OR DEVELOPMENT

Certain embodiments of the inventions disclosed herein were made with U.S. Government support under SBIR Contract Number M67854-05-C-0029, Topic N03-157 awarded by the U.S. Navy. Accordingly, the Government may have certain rights in embodiments disclosed herein.

### FIELD OF THE INVENTION

The field of the invention relates to composite materials and the fabrication thereof, for use as insulators in environments that may include high temperatures, high noise levels, and/or corrosive environments. Aspects of the invention are directed to manufacture of sandwich composite materials using processes such as vacuum assisted resin transfer molding (VARTM).

### BACKGROUND OF THE INVENTION

Insulation technologies continue to advance in the commercial marketplace. However, commercially available materials exhibit one or several limitations preventing their use in various applications, such as with hot and/or noisy pieces of equipment including the engine, transmission, power transfer module, and cooling fans in automobile applications.

Aerogels are materials often considered for insulation applications due to their low thermal conductivity. Generally, aerogels are a special class of open-cell foams with unique thermal, chemical, acoustic, optical and electrical properties. They typically have high porosity (>90%), low density (<0.4 g/cm³), ultrafine pore sizes (<50 nm), high internal surface area (400-1000 m²/g), and a solid matrix composed of inter-connected fibrous chains with characteristic diameters of 10 nm. A characteristic of aerogels is low mechanical stability, leading to efforts towards fabricating aerogel composites to combine the low thermal conductivity of aerogels with the structural integrity of other materials, such as fibers. Aerogel blankets, including aerogel/fiber composite blankets, are available commercially.

Vacuum assisted resin transfer molding (VARTM) is a known process for fabricating a composite part by infusing resin into a part, for example, a fibrous preform. VARTM employs a fluid-impervious outer sheet or bag to isolate the part and allow a vacuum to draw resin into the preform. Many improvements have been made on the VARTM method, such as the use of distribution media to more evenly deliver the resin onto the part. High permeability layers (HPL), or breathers, may also be utilized to assist with thorough evacuation of the air within the system and provide a non-directional flow front for improved resin delivery. Another development in the field is co-injection resin transfer molding (CIRTM), in which multiple different resins are simultaneously injected into the part or multiple resins are injected sequentially into one area of the part.

### SUMMARY OF THE INVENTION

The present invention relates to a sandwich composite construction, and method of fabrication, for use as an insulator. The sandwich composite construction is particularly advantageous in applications requiring a lightweight, mechanically stable material to provide thermal and acoustical insulation. For employment in areas with complex geometry, water soluble tooling may be used as a substrate on which the sandwich composite construction is fabricated. The sandwich composite construction may be manufactured using a vacuum assisted resin transfer molding method (VARTM) subsequent to providing a preform comprising elements of fibrous material, aerogel, separation material and resin. Additionally, an insulative material element, such as a foam, may be provided in the composite construction. A plurality of each element may be included throughout the composite. Numerous embodiments of the present invention are described herein to show tailorable properties of the sandwich composite construction.

There remains a need for an appropriate insulation material with superior thermal and acoustic properties. There also remains a need for multi-functional thermal and acoustic barrier materials that also are capable of resistance to fluids (seawater, oil, and fuel), and to various forms of corrosion. In addition, these newly designed materials must be lightweight, affordable and easily packaged for use in numerous applications.

### BRIEF DESCRIPTION OF THE DRAWINGS

FIG. 1a is a schematic cross-sectional view of a first sandwich composite construction in accordance with the embodiments of the invention;

FIG. 1b is a schematic cross-sectional view of a second sandwich composite construction in accordance with the embodiments of the invention;

FIG. 2 is a graphical representation of the insulative effect of a sandwich composite construction including a single aerogel layer in accordance with the embodiments of the invention, showing the temperature differential across the sandwich composite construction when one side is exposed to a temperature of about 200° F.;

FIG. 3 is a graphical representation of the insulative effect of a sandwich composite construction including a single aerogel layer in accordance with the embodiments of the invention, showing the temperature differential across the sandwich composite construction when one side is exposed to a temperature of about 300° F.;

FIG. 4 is a graphical representation of the insulative effect of a sandwich composite construction including four aerogel layers in accordance with the embodiments of the invention, showing the temperature differential across the sandwich composite construction when one side is exposed to a temperature of about 200° F.;

FIG. 5 is a graphical representation of the insulative effect of a sandwich composite construction including four aerogel layers in accordance with the embodiments of the invention, showing the temperature differential across the sandwich composite construction when one side is exposed to a temperature of about 300° F.;

FIG. 6 is a graphical representation of the insulative effect of a sandwich composite construction including four aerogel layers in accordance with the embodiments of the invention, showing the temperature differential across the sandwich composite construction when one side is exposed to a temperature of about 390° F.;

FIG. 7 is a thermal image of the sandwich composite construction of FIG. 2;

FIG. 8 is a thermal image of the sandwich composite construction of FIG. 3;

FIG. 9 is a thermal image of the sandwich composite construction of FIG. 5;

FIG. 10a is a graphical representation of the acoustical insulative effect of sandwich composite constructions in accordance with the embodiments of the invention;

FIG. 10b is a second graphical representation of the acoustical insulative effect of the sandwich composite constructions of FIG. 10a;

FIG. 10c is a graphical representation of the acoustical insulative effect of sandwich composite construction in accordance with embodiments of the invention.

FIG. 10d is a graphical representation of the acoustical insulative effect of sandwich composite constructions in accordance with embodiments of the invention;

FIG. 11a is a graphical representation of the acoustical insulative effect of sandwich composite constructions in accordance with the embodiments of the invention, showing the effect of pressure on the insulative effect;

FIG. 11b is a second graphical representation of the acoustical insulative effect of the sandwich composite constructions of FIG. 11a;

FIG. 12 is a graphical representation of the flexure strength of sandwich composite constructions including a single layer of aerogel in accordance with the embodiments of the invention;

FIG. 13 is a graphical representation of the measured load-displacement of the sandwich composite constructions of FIG. 12;

FIG. 14 is a schematic illustration of a first assembly for manufacture of sandwich composite constructions in accordance with the embodiments of the invention; and

FIG. 15 is a schematic illustration of a second assembly for manufacture of sandwich composite constructions in accordance with the embodiments of the invention.

### DETAILED DESCRIPTION OF EMBODIMENTS OF THE INVENTION

The present disclosure provides sandwich composite constructions and methods of manufacture. In certain embodiments, the composite materials employ silica-based aerogel materials as part of a layered composite material. The sandwich composite materials may act as thermal insulators to provide protection against elevated temperatures, as well as resistance to fire. The sandwich composite materials may act as acoustic insulators by reducing the transmission of noise at various frequencies.

In certain applications, it is desirable to utilize multifunctional composite materials having properties such as thermal and acoustic insulation while also providing mechanical integrity. In general, the composite constructions disclosed herein are structurally rigid and withstand various impact forces. By way of example, the composite materials may withstand an impact force of five pounds per square inch or more. In certain embodiments, the composite materials provide enhanced structural rigidity and impact resistance as compared to other materials such as polymer materials. In addition to being structurally rigid, the composite materials also typically are lightweight. In certain embodiments, the weight of the materials is no more than about three pounds per square foot of composite material.

In certain embodiments, the composite constructions have a K value of approximately 0.0305 BTU/hr-ft-° F. for one inch of thickness. In certain embodiments, the surface temperature on the cool side of the composite materials can be maintained at between about 130° F. to about 150° F. or less, or at about 100° F., when the temperature on the hot side is about 250° F. or more. In certain embodiments, the surface temperature on the cool side of the composite materials can be maintained at about 120° F. or less, or at about 100° F. or less, when the temperature on the hot side is about 400° F. or more. Additionally, a protective layer can be utilized on the surface of the composite material facing the hot side to limit the flammability of the material and provide resistance to fire. In certain embodiments, a layer of material having a thickness sufficient to be flame-retardant or flame-resistant is included at or near the outer surface of the composite materials. The layer may be made of a phenolic resin or other suitable material and may have a thickness of between about 0.08 to about 0.1 inches. For complex-shaped structures, the hot side of the structure may be coated with flame-resistant or flame-retardant material.

The composite materials have noise reducing properties. In certain embodiments, the composite materials have a Transmission Loss Factor (STC) of between about 32 to about 36. The composite materials provide the characteristic of acoustic attenuation. In certain embodiments, the materials provide a Transmission Loss (TL) in decibels (dB) when tested at an amplitude of about 1.5 volts as follows:

TABLE 1

| Octave Band Frequency - f (Hz) | TL (dB) |
|---|---|
| 125 | 20 |
| 250 | 25 |
| 500 | 30 |
| 1000 | 35 |
| 2000 | 40 |
| 4000 | 42 |
| 8000 | 45 |

Generally, the sandwich construction includes a fibrous material/resin composite system and an aerogel sandwich material isolated from the resin matrix through a separation material. A fibrous material, such as fiberglass fabric, can be secured to or about a flexible silica aerogel material and then infiltrated with a resin system which may be an epoxy based resin. Such a composite material system is suitable for thermal and acoustic barrier applications and overcomes the difficulties associated with use of commercially-available flexible aerogel materials.

The composite materials are resistant to fluids and corrosion. Corrosive conditions may be encountered due at least in part to fluids present in the operating environment or contact with other surrounding materials. Fluids that may be present in the operating environment include sea water, ethylene glycol, diesel fuel, hydraulic fluid, battery acid and the like.

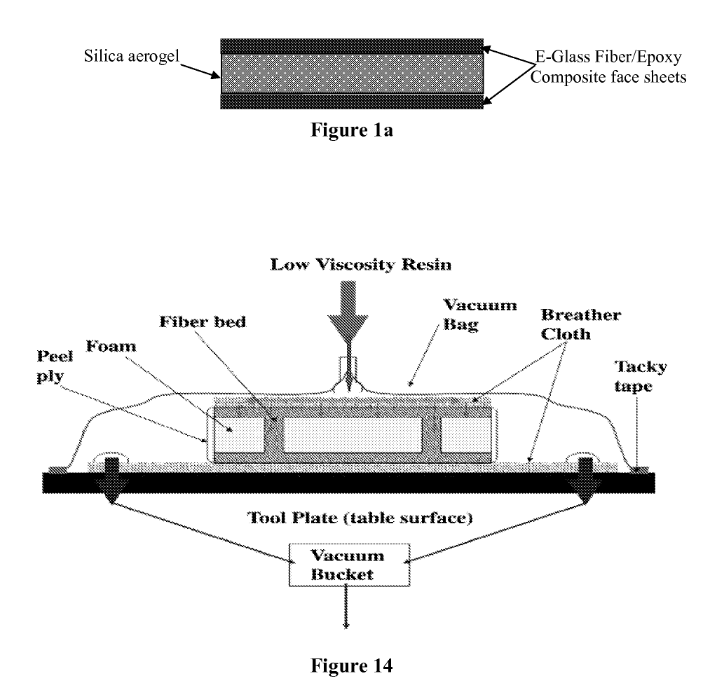

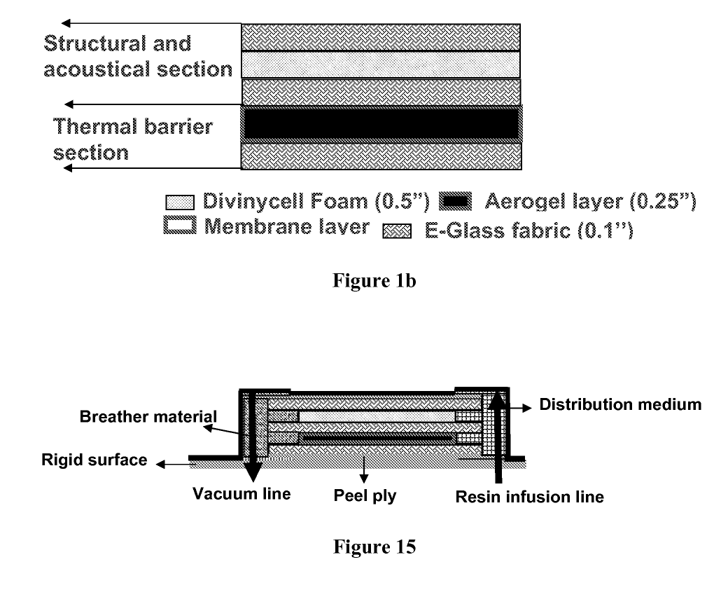

The insulating materials of the various embodiments include sandwich construction configurations that impart tailorable properties to the constructions, e.g., thermal protection and/or acoustic protection, depending on the service environment. As shown in FIG. 1a, the sandwich constructions can include glass fiber/epoxy face sheets, with the core layer composed of silica aerogel. Fiberglass materials include Three Weave (96 ounce) fabric and 7781 E-Glass fabrics. Suitable aerogel materials include flexible silica aerogel materials, such as Spaceloft™ and Pyrogel® aerogels (Aspen Aerogels, Inc., Massachusetts), Microlite® AA Blankets (John Manville, Inc.), Silicaflex™ Blanket (ADL Insulflex). In certain embodiments, a separation layer is provided between the silica aerogel material and the fiberglass fabric. Suitable materials for the separation layer include a Gore membrane, such as Albatros (W.L. Gore & Associates, GmbH, Germany). The separation layer limits the flow of resin into the silica aerogel material from the fiberglass fabric.

Other numbers and combinations of layers to form the composite constructions also are contemplated as being within the scope of the invention. For example, one, four, six, or more layers of silica aerogel material may be provided between two fiberglass face sheets. As another example, one, two or more sheets of fiberglass fabric may be provided on the surface of the aerogel material. Various combinations of layers of fiberglass fabric, aerogel material and other structural and/or insulative materials also are contemplated. As an example, one or more foam materials may be included in the composite constructions to provide enhanced strength and/or insulation. One suitable foam material is Divinycell® PVC foam (Grades H45 and H60), which can provide structural integrity and acoustical shielding. FIG. 1b illustrates a combination sandwich composite that includes an aerogel material and a foam material. The aerogel and foam materials are sandwiched between layers of fiberglass fabric, with membrane layers located on either side of the aerogel layer between the aerogel layer and the fiberglass fabric layers. The methods according to embodiments of the present invention provide sandwich composite constructions having enhanced thermal and acoustic properties with reduced thicknesses, even as much as half the thickness of conventional insulations.

In one aspect of the invention, a one-step co-curing fabrication process (co-injection resin transfer method or “CIRTM”) can be used to manufacture the sandwich composites. That is, highly viscous resin slurries can be co-injected into fibrous preforms. In another aspect of the invention, a vacuum assisted resin transfer method (VARTM) can be used to manufacture the sandwich composites.

Referring to FIG. 14, an assembly for making the sandwich composite constructions utilizes a vacuum assisted resin transfer process. In this process, a fiberglass fabric is positioned adjacent the top and bottom surfaces of the silica aerogel material. The fiberglass fabric/silica aerogel preform is maintained under vacuum conditions. An epoxy-based resin system, such as a vinyl ester resin, such as Derakane 411-350 (Ashland), or Huntsman or SC-11, SC-79 (Applied Poleramic Inc.), or other suitable resin system, is injected into the preform so that it infiltrates the fiberglass fabric to form fiberglass/epoxy composite face sheets on the top and bottom of the silica aerogel material.

Referring to FIG. 15, another assembly for making the sandwich composite constructions is illustrated. In this assembly, the three layers of fiberglass fabric are simultaneously infused with the resin system under a vacuum to assist the infusion. After the resin system is infused into the panel, the panel is cured, such as at room temperature for a sufficient time. The panel also may be post-cured at an elevated temperature for a suitable period of time, for example at about 110° C. for about two hours.

In other aspects, a water soluble tooling material can be used to fabricate sandwich panels having complex geometries. One such water soluble tooling material is described in U.S. Pat. No. 6,828,373, incorporated herein by reference. The sandwich constructions are made as described above except that the water soluble tooling material is used as the substrate instead of a flat surface. The ability to directly fabricate complex geometries provides the ability to make sandwich panels to fit any given profile in a design. The composite panels can also be fabricated for modular construction to provide high repair/replaceability at low cost.

The composite constructions can be used in various applications. In particular, it may be desirable to use the composite constructions in applications where elevated temperatures and/or noise may be encountered. Examples of possible applications include uses in automotive, aircraft and housing constructions, such as for engines, transmission components, power transfer modules, cooling fans, and hull frames. Primers and/or topcoat paints also can be applied to the surface of the composite constructions to provide additional sealing properties or aesthetic characteristics, as desired.

The following examples are intended to illustrate embodiments of the present invention and should not be construed as in any way limiting or restricting the scope of the present invention. The following examples illustrate the fabrication process for sandwich composite materials and testing of properties, such as thermal and acoustic properties, of the composite materials.

### EXAMPLES

### Example 1

A first panel of the sandwich composite material was made to evaluate the fabrication process. The panel was made with plies in the following arrangement:
6 layers 7781 glass fabric (25″×25″)
1 layer “Gore” membrane (16″×16″)
1 layer aerogel (12″×12″)
1 layer “Gore” membrane (16″×16″)
6 layers 7781 glass fabric (25″×25″)

This fabrication attempted to isolate the aerogel from the resin while using a one-step infusion process. The edges of the panel were closed out to both incorporate the aerogel and to provide mounting points for the panel. The separation membrane was sealed to itself around the aerogel using “tacky-tape”. This panel was infused from both sides to completely encapsulate the aerogel. Post inspection of the panel indicated that the aerogel remained dry during the infusion process. After processing, the aerogel compressed from about 5.6 mm down to about 4.7 mm.

A second panel was constructed to further evaluate the manufacturing process of the first panel. The second panel included the same construction layers but with slight modifications to the membrane configuration and edge sealing details to improve manufacturability. It was infused with Vantico/Huntsman Resinfusion 8605 resin and postcured. This second panel subsequently was used for thermal and mechanical testing.

### Example 2

A set of panels was made for acoustic testing. These panels followed the form of panels of Example 1. The construction was as follows.
A panel with a core of one layer of aerogel encapsulated by a Gore isolation membrane. Two layers of glass fabric made the top and bottom face sheets. The panel was infused with SC-15 epoxy to a final dimension of 3 feet by 5 feet.
A panel with a core of four layers of aerogel encapsulated by a Gore isolation membrane. Two layers of glass fabric made the top and bottom face sheets. The panel was infused with SC-15 epoxy to a final dimension of 3 feet by 5 feet.

The sandwich construction panels were made with plies in the following consecutive arrangement:
2 layers 7781 glass fabric (36″×60″)
1 layer “Gore” membrane (36″×60″)
1 and 4 layers aerogel (respectively) (36″×60″)
1 layer “Gore” membrane (36″×60″)
2 layers 7781 glass fabric (36″×60″)

### Example 3

An additional set of panels (panels 4 and 5) was constructed for acoustic testing using the VARTM method. The sandwich construction panels were made with plies in the following consecutive arrangement:
1 layer 96 oz or 54 oz 7781 fiberglass fabric (respectively) (60″×45″)
1 layer “Gore” membrane (60″×40″)
1 layer aerogel (35.5″×55.5″)
1 layer “Gore” membrane (60″×40″)
1 layer 96 oz or 54 oz 7781 fiberglass fabric (respectively) (60″×45″)
1 layer foam Grade H60 (36″×56″×0.54″)
1 layer 96 oz or 54 oz 7781 fiberglass fabric (respectively) (60″×45″)

The panels were constructed according to the method described in Example 1. To ensure timely and even resin infusion into the panels, 5 inch width distribution media and high permeability layers (breathers) were placed opposite one another along the long sides of the panel. Three layers of each were provided, such that the three fiberglass fabric materials would all simultaneously receive infusion of the resin system.

Omega channels of lengths of 53.5 inch and 61 inch were placed on the top breather and two vent channels were connected. This external vent line was connected to a bypass tubing assembly to control the bleed-out of the resin. A 55 inch Omega channel was placed on the distribution media.

The entire part was bagged with gas-impermeable sheeting, then vacuum pressure was applied and the sealing was ensured for 15 minutes. Care was taken that all sides of the lay-up were under vacuum pressure.

Both panels 4 and 5 were infused for two hours with a vinyl ester resin (Derakane 8084) system. Additives to the resin included DMA, 2,4-pentadione, cobalt (Conap) and peroxide (Trigonox).

The panels were allowed to cure for 24 hours, followed by postcuring at 80° C. for six hours. The final dimensions and surface masses of the postcured panels are given in Table 2.

TABLE 2

| | | | Surface |
|---|---|---|---|
| | | Dimensions | mass |
| | | (in.) | (lb/in²) |
| Panel 4 | 96-oz face sheet/Foam H60/96-oz face | 1 × 39 × 59 | 3.27 |
| | sheet/Aerogel/96-oz face sheet | | |
| Panel 5 | 54-oz face sheet/Foam H60/54-oz face | 1 × 39 × 59 | 2.5 |
| | sheet/Aerogel/96-oz face sheet | | |

### Example 4

Thermal testing was conducted on panels of different aerogel thicknesses. In the bench-scale experimental setup, the panels of Example 1 were placed on a hot plate with a small standoff distance. The edges of the panels were insulted in order to better contain hot air in the cavity below the panel. Thermocouples were placed on the hot plate surface on the bottom, or “hot” side, and the top, or “cold” side, of the panel. The hot side was initially heated to about 200° F., and the temperature on the “cold” side was recorded. The temperature on the “hot” side was increased to 300° F. and 390° F. and additional measurement were taken. The results are shown in Table 3.

TABLE 3

| | One Layer Aerogel | | Four Layers Aerogel | |
|---|---|---|---|---|
| | Bottom (hot) | Top (cold) | Bottom (hot) | Top (cold) |
| | Surface | Surface | Surface | Surface |
| | (° F.) | (° F.) | (° F.) | (° F.) |
| 200° F. | 200 | 90 | 200 | 82 |
| 300° F. | 300 | 100 | 300 | 85 |
| 390° F. | | | 390 | 97 |

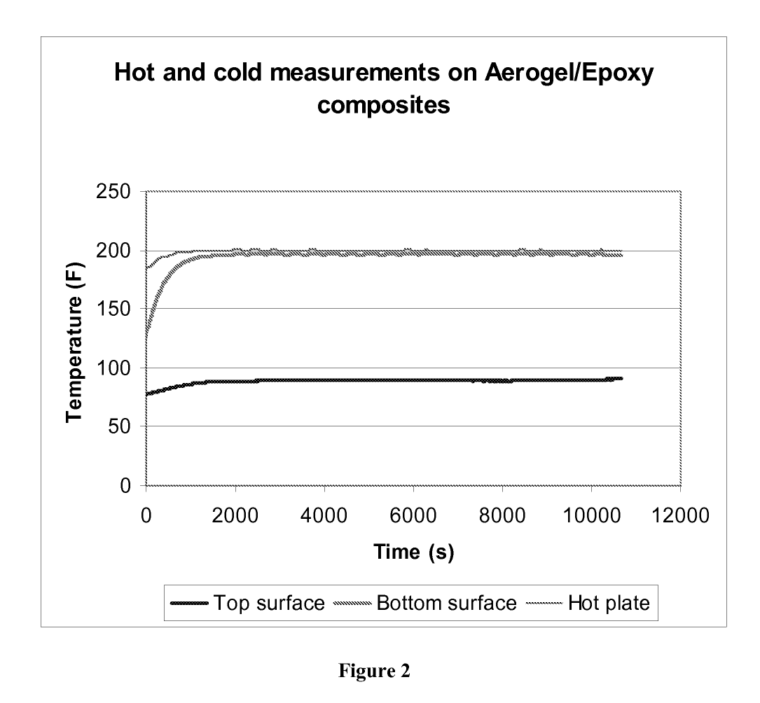

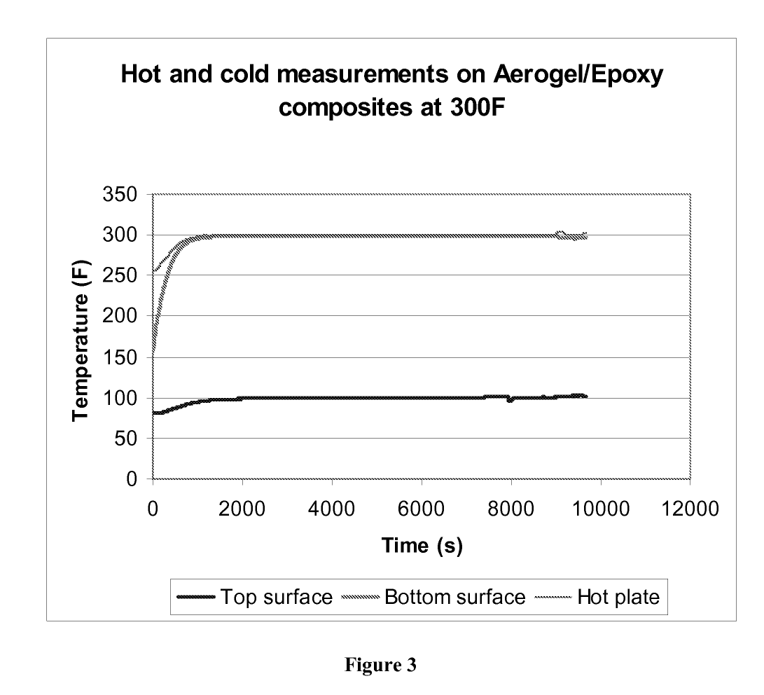

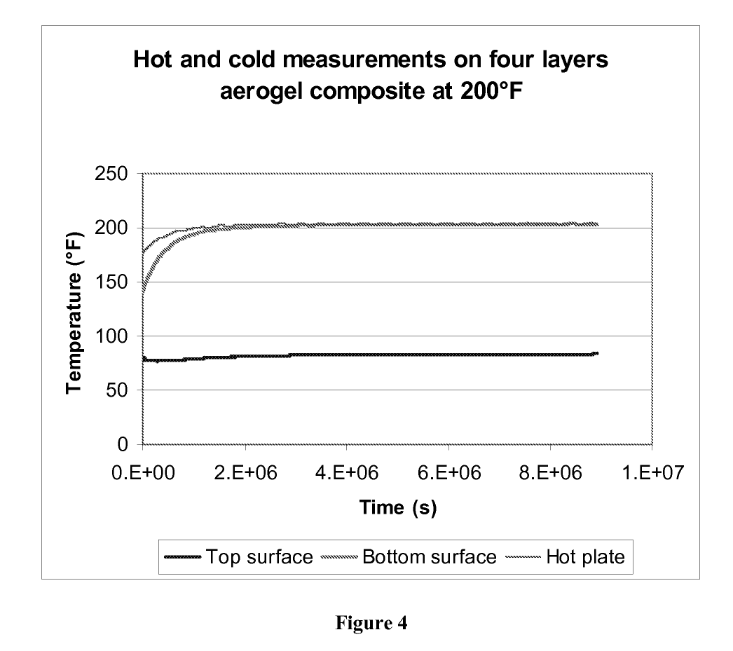

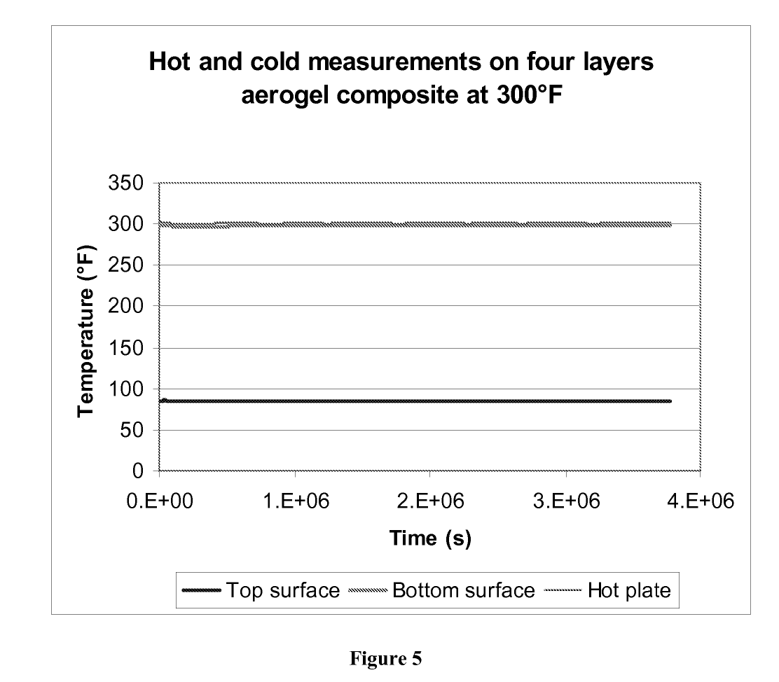

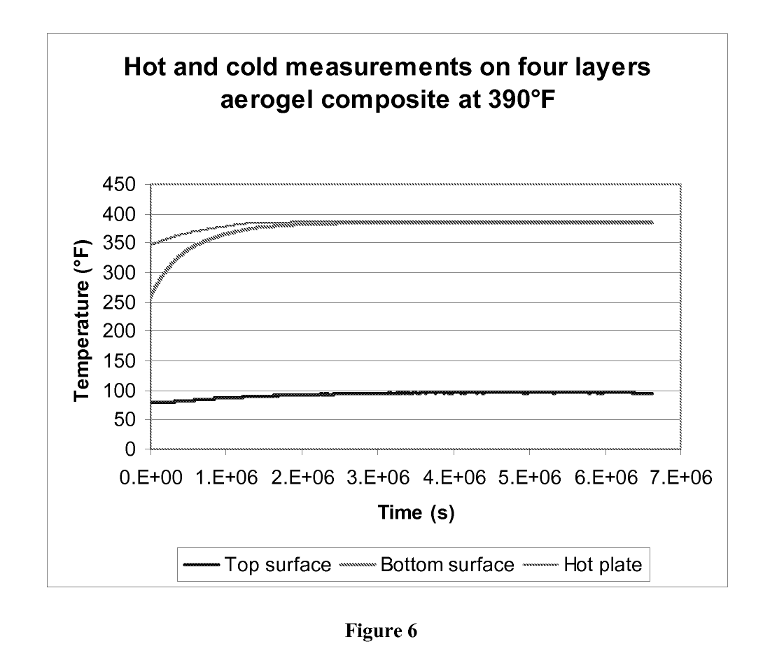

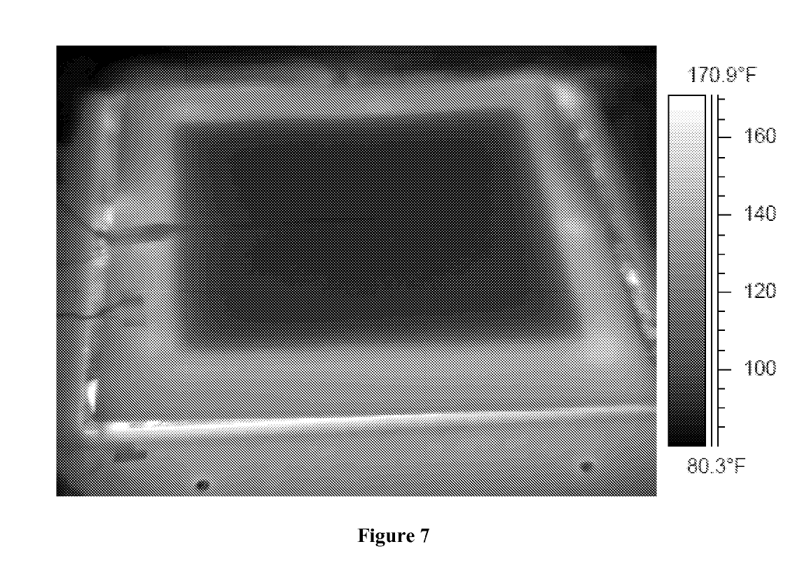

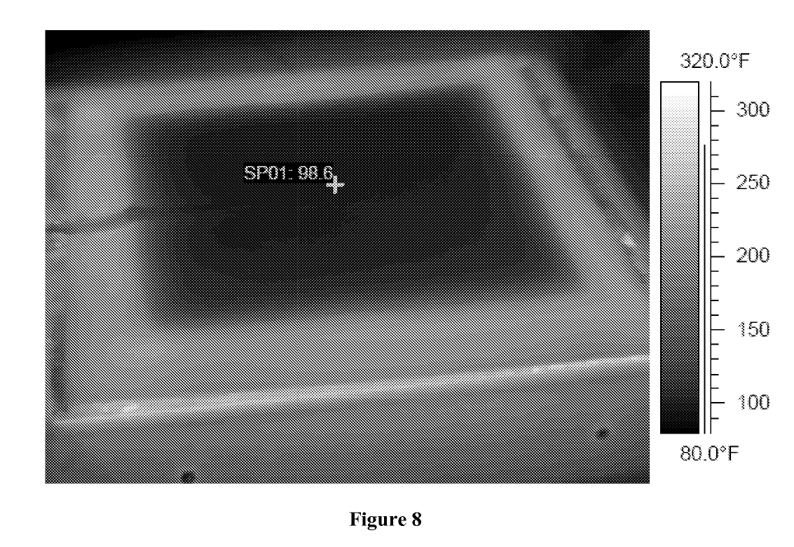

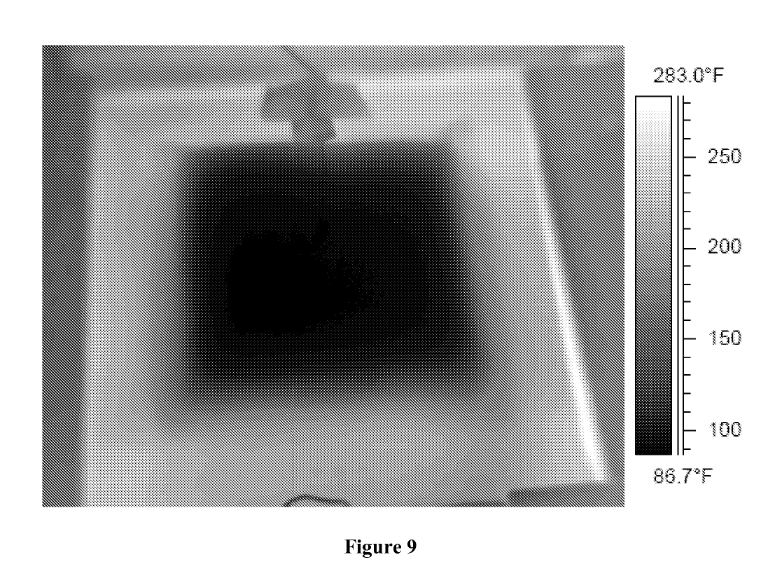

The results are further illustrated in FIGS. 2-6, which illustrate the temperature measurements over time for a one-layer panel at 200° F. (FIG. 2) and 300° F. (FIG. 3) and a four-layer panel at 200° F. (FIG. 4), 300° F. (FIG. 5), and 390° F. (FIG. 6). FIGS. 7-9 illustrate the corresponding thermal images for the one-layer panel at 200° F. (FIG. 7) and 300° F. (FIG. 8) and the four-layer panel at 300° F. (FIG. 9).

### Example 5

Acoustic testing was conducted using a bench-scale experimental setup that included a sound generator, amplifier, speaker (sound driver), sound meter and oscilloscope. Acoustic measurements were performed on 6″×6″ panels of the one layer and four layer sandwich constructions of Example 2. The panels had a thickness of 0.4 inch and 1 inch for the one-layer and four-layer aerogel panels, respectively.

Table 4 shows TL values for one-layer and four-layer aerogel panels. Table 5 shows the normalized values of TL by sound pressure levels (SPL) (air).

TABLE 4

| | One-Layer | |
|---|---|---|
| | Aerogel | Four-Layer Aerogel |
| Octave Band Frequency - f (Hz) | TL (dB) | TL (dB) |
| 125 | 28 | 19 |
| 250 | 44 | 32 |
| 500 | 37 | 36 |
| 1000 | 42 | 48 |
| 2000 | 40 | 49 |
| 4000 | 46 | 45 |
| 8000 | 44 | 49 |

TABLE 5

| | One-Layer | |
|---|---|---|
| | Aerogel | Four-Layer Aerogel |
| Octave Band Frequency - f (Hz) | TL (%) | TL (%) |
| 125 | 26 | 20 |
| 250 | 36 | 29 |
| 500 | 30 | 33 |
| 1000 | 33 | 41 |
| 2000 | 32 | 39 |
| 4000 | 13 | 37 |
| 8000 | 35 | 42 |

The results indicate that the four-layer construction provides enhanced acoustic performance/noise reduction at high frequencies as compared to the one-layer construction. In the lower frequency range, 125-500 Hz, noise appears to affect the results of the experimental setup.

### Example 6

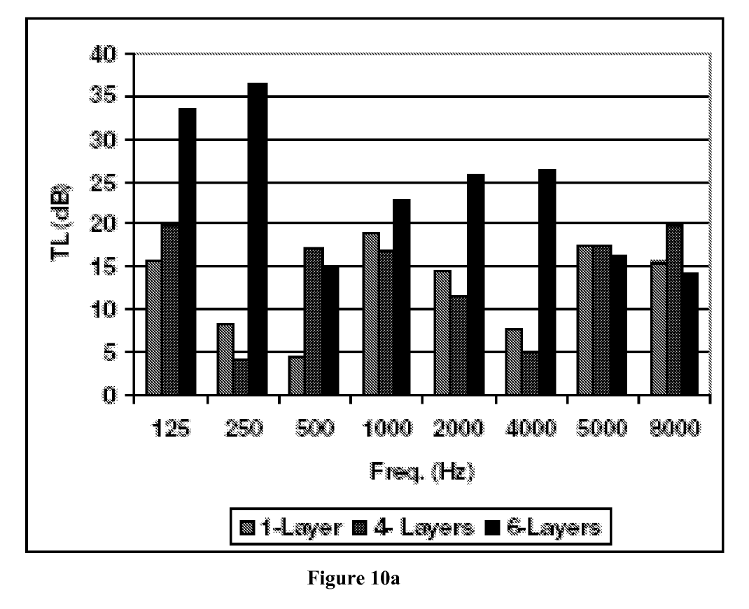

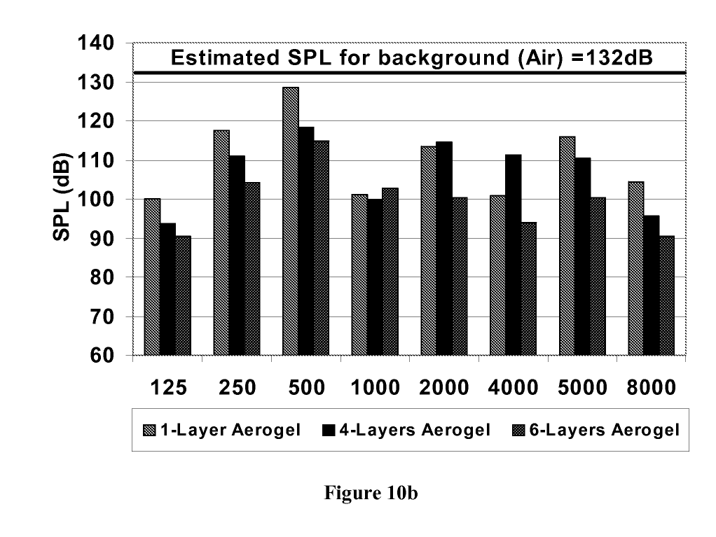

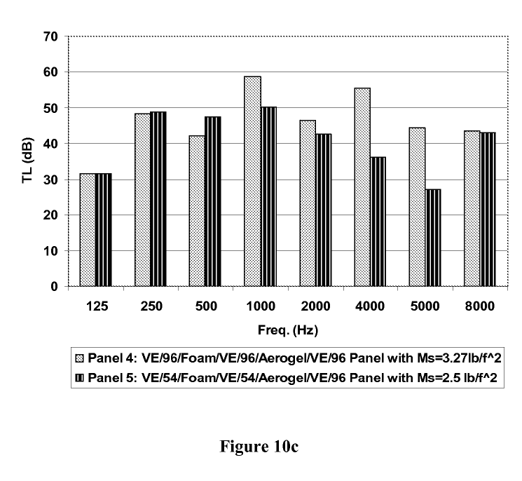

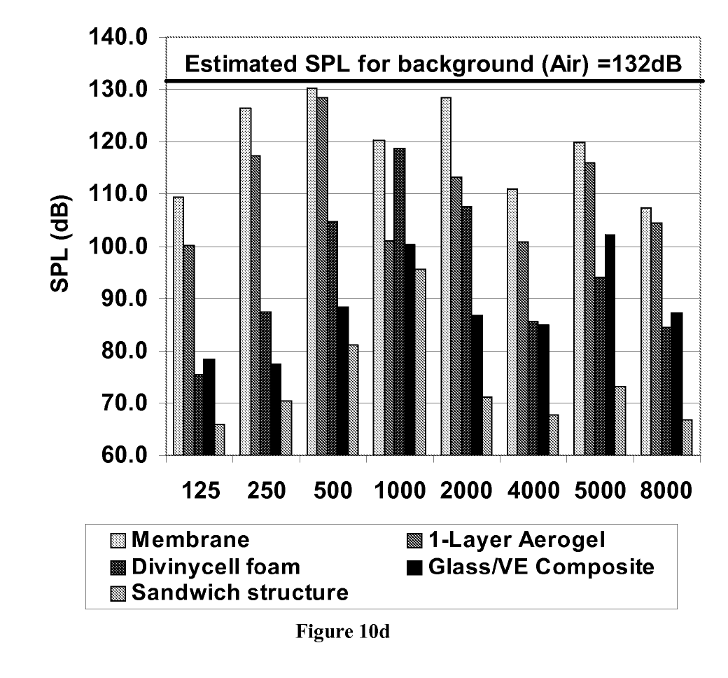

A second test of the acoustic properties of the panels was conducted with one-layer and four-layer panels using the setup of Example 5. Additionally, panels including six layers of aerogel also were tested. The transmission loss factors for each of the panels at the various test frequencies are set forth in FIG. 10a and the normalized values of TL by sound pressure levels (SPL) are set forth in FIG. 10b. FIG. 10c illustrates the transmission loss values for panels 4 and 5 from Example 3. The TL is greater for panels 4 and 5 in the middle frequencies than for panels 1 and 2.

The tests were conducted on one-layer and four-layer panels at pressures of 14.7 psi and 0 psi to evaluate the effects of vacuum pressure. The results are shown in FIGS. 11a and 11b. Vacuum pressure did not have an effect on SPL values. A 25% reduction in aerogel thickness was observed. Overall, vacuum pressure will affect the acoustic properties of the sandwich constructions. The vacuum pressure had less impact on TL values for four-layer samples than for one-layer samples. At higher frequencies, one layer samples exhibited higher attenuation under a pressure of 14.7 psi as compared to a lower frequency (125 Hz) under zero pressure.

### Example 7

Comparative acoustical testing was conducted for a sandwich construction including face sheets, foam and aerogel materials and also separately for the different materials of the sandwich constructions. The results are shown in FIG. 10d. As can be seen, the sandwich structure exhibited the greatest losses.

### Example 8

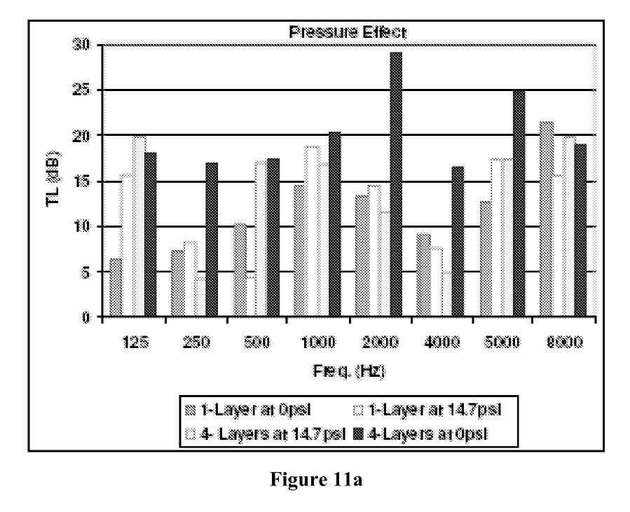

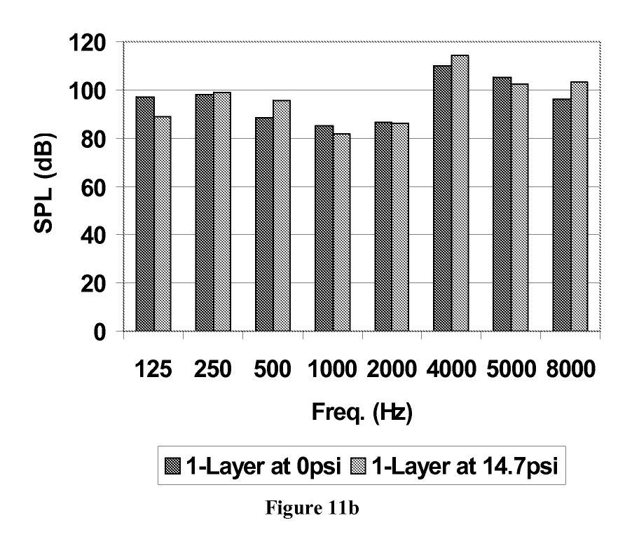

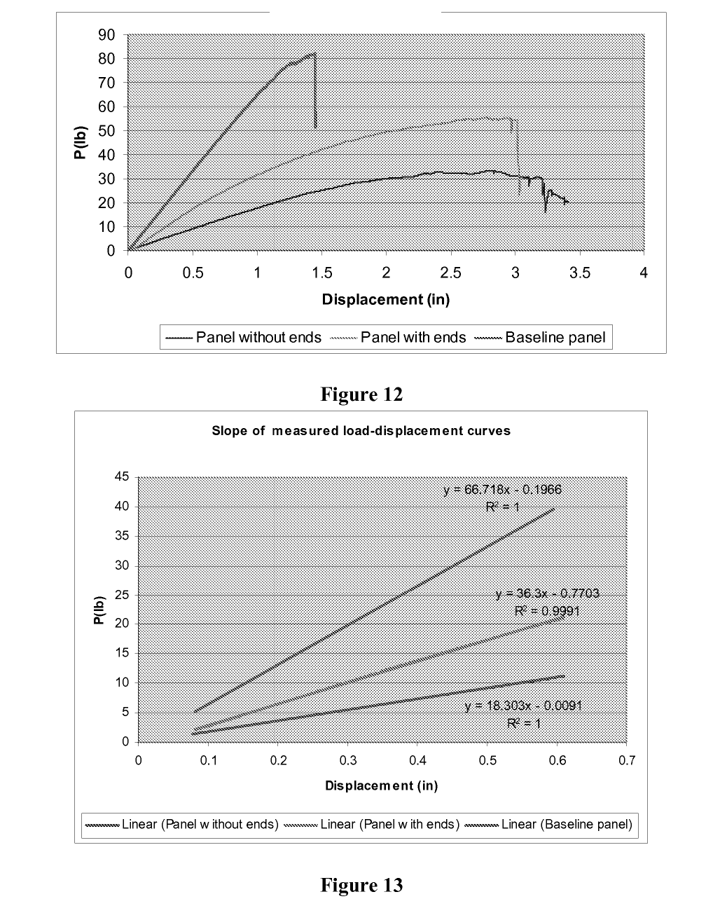

The mechanical strength of the composite materials was tested in accordance with D790 ASTM Standard. Four point bend tests were conducted on the panels of Example 1 to evaluate the structural integrity of the panels. The results of the flexure tests are set forth in Table 6 and further illustrated in FIGS. 12 and 13.

TABLE 6

| Panel | Failure Load (lb) | MC (lb · in) | Slope (lb/in) |
|---|---|---|---|
| Baseline | 82 | 205.5 | 67 |
| With Ends | 54 | 136 | 36 |
| Without Ends | 30 | 75 | 18 |

Based on this testing, the composite constructions should withstand loads of five pound per square inch or greater.

Numerous modifications and variations may be made in the techniques and structures described and illustrated herein without departing from the spirit and scope of the present invention. Thus, modifications and variations in the practice of the invention will be apparent to those skilled in the art upon consideration of the foregoing detailed description of the invention. Although preferred embodiments have been described above and illustrated in the accompanying drawings, there is no intent to limit the scope of the invention to these or other particular embodiments. Consequently, any such modifications and variations are intended to be included within the scope of the following claims.

What is claimed is:

1. A sandwich composite construction comprising:
a. a first fibrous material including porous spaces at least partially filled by a resin;
b. a second fibrous material including porous spaces at least partially filled by the resin;
c. a first aerogel layer disposed between the first and second fibrous materials;
d. a first separation material limiting the resin from traversing between the first fibrous material and the aerogel layer; and
e. a second separation material limiting the resin from traversing between the second fibrous material and the aerogel layer.

2. The sandwich composite construction of claim 1 further comprising:
a. a third fibrous material including porous spaces at least partially filled by the resin; and
b. a first insulative material layer disposed between the second fibrous material and the third fibrous material.

3. The sandwich composite construction of claim 1 further comprising a plurality of aerogel layers, fibrous materials, or a combination thereof.

4. The sandwich composite construction of claim 3 further comprising a plurality of insulative material layers.

5. The sandwich composite construction of claim 4, wherein the weight of the materials is no more than about three pounds per square foot of sandwich composite construction.

6. The sandwich composite construction of claim 2, wherein the aerogel layer is comprised of a silica-based aerogel material.

7. The sandwich composite construction of claim 1, wherein the separation material comprises a Gore membrane.

8. The sandwich composite construction of claim 2 further comprising flame-resistant and/or flame-retardant material coated on the outer surfaces of the construction.

9. The sandwich composite construction of claim 1, wherein the sandwich composite construction generally maintains structural rigidity when subjected to an impact force of five pounds per square inch.

10. The sandwich composite construction of claim 3, wherein the temperature differential across the sandwich composite construction is at least approximately 100° F. when one side is exposed to a temperature of about 200° F. and when the number of aerogel layers is at least one.

11. The sandwich composite construction of claim 3, wherein the temperature differential across the sandwich composite construction is at least approximately 290° F. when one side is exposed to a temperature of about 390° F. and when the number of aerogel layers is at least four.

12. The sandwich composite construction of claim 4, wherein the decibel Transmission Loss across the sandwich composite construction is at least 20 and the Transmission Loss Factor (STC) is at least 31 when it is exposed to frequencies of 125-8000 hertz at an amplitude of 1.5 volts, and the number of insulation layers is at least one.

13. A method of fabricating a sandwich composite construction comprising:
a. utilizing a water-soluble tooling material as a substrate for a lay-up;
b. maintaining a vacuum on the lay-up, the lay-up including:
a fibrous material/separation material/aerogel/separation material/fibrous material/insulative material/fibrous material preform;
a separate distribution media placed along an edge of the preform in communication with each fibrous material element;
a separate breather material placed along an edge of the preform in communication with each fibrous material element and parallel to the distribution media elements; and
a gas-impervious sheet or bag encapsulating the lay-up;
c. injecting an epoxy-based resin system into the preform through the distribution media elements such that it infiltrates the fibrous materials to form fibrous/epoxy composites; and
d. curing the construction at room temperature.

14. The method of claim 13, wherein the epoxy-based resin system comprises a vinyl ester resin.

15. The method of claim 14, wherein the epoxy-based resin system further comprises a resin additive.

16. The method of claim 13 further including the step of sealing the separation membrane to itself around the aerogel with an adhesive material.

17. The method of claim 13 further including the step of post-curing the construction at an elevated temperature.

18. The method of claim 13 further including the step of coating the outer surfaces of the sandwich composite construction with a flame-resistant and/or flame-retardant material.

19. A sandwich composite construction fabricated by the process comprising:
a. utilizing a water-soluble tooling material as a substrate for a lay-up;
b. maintaining a vacuum on the lay-up including
a fibrous material/separation material/aerogel/separation material/fibrous material/insulative material/fibrous material preform;
a separate distribution media placed along an edge of the preform in communication with each fibrous material element;
a separate breather material placed along an edge of the preform in communication with each fibrous material element and parallel to the distribution media elements; and
a gas-impervious sheet or bag encapsulating the lay-up;
c. injecting an epoxy-based resin system into the preform through the distribution media elements such that it infiltrates the fibrous materials to form fibrous/epoxy composites;
d. curing the construction at room temperature;
e. post-curing the construction at an elevated temperature; and
f. coating the outer surfaces of the construction with a flame-resistant and/or flame-retardant material.

20. The sandwich composite construction of claim 19 further comprising a plurality of aerogel layers, fibrous materials, insulative materials, or a combination thereof.
